(19) United States
(12) Patent Application Publication
(10) Pub. No.: US 2026/0205261 A1
(43) Pub. Date: Jul. 16, 2026

(54) METHOD AND SYSTEM FOR NON-INTERACTIVE SECURE AGGREGATION

(71) Applicant: JPMorgan Chase Bank, N.A., New York, NY (US)

(72) Inventors: Harish KARTHIKEYAN, Manhattan, NY (US); Antigoni Ourania POLYCHRONIADOU, New York, NY (US)

(73) Assignee: JPMorgan Chase Bank, N.A., New York, NY (US)

(21) Appl. No.: 19/039,110

(22) Filed: Jan. 28, 2025

(30) Foreign Application Priority Data
Jan. 16, 2025 (GR) 20250100029

(51) Int. Cl. H04L 9/06

(52) U.S. Cl. CPC H04L 9/06; H04L 2209/046; H04L 2209/08

(57) ABSTRACT

A method for providing a secure aggregation protocol that minimizes interactions in secure computations in order to reduce costs and mitigate challenges of communication rounds while preserving participant privacy is provided. The method includes: receiving, from each of a set of first users, a respective first ciphertext that masks a respective first input; forwarding, to a committee of second users, respective second ciphertexts received from the first users; receiving, from the second users, a respective second input that relates to a respective combination of third inputs recovered from the second ciphertexts received by each second user; combining the second inputs to generate a first unmasking component; combining the first ciphertexts in order to generate an aggregated ciphertext; and generating an unmasked aggregate of the first inputs by using the first unmasking component and the aggregated ciphertext. The unmasked version of the first input is unknowable by the other participants.

### CROSS-REFERENCE TO RELATED APPLICATIONS

This application claims priority from Greek patent application No. 20250100029, filed in the Greek Patent Office on Jan. 16, 2025, which is hereby incorporated by reference in its entirety.

### BACKGROUND

### 1. Field of the Disclosure

This technology relates to a method and a system for providing a secure aggregation protocol that minimizes interactions in secure computations in order to reduce costs and mitigate challenges of communication rounds while preserving security guarantees.

### 2. Background Information

In federated learning (FL), the goal of the server is to train a global model by utilizing data that solely reside on clients' devices, such as, for example, mobile phones. In each iteration, a subset of clients are chosen and asked to train the current global model (represented as weights of the underlying model) by using their local data. Upon completing the training, each client is expected to send their updated local model weights to the server. The server updates the global model by averaging the clients' updates. This process is repeated until convergence is achieved. The process, as described above, only requires clients to interact once with the server. Furthermore, the data never leaves the client's device. While naively, this seems to offer the privacy of the data, attacks have shown that the updates can still leak information about the client data. This is the motivation behind secure aggregation, a protocol that allows the server to compute the sum without leaking information about the clients' data.

The problem of secure aggregation is closely related to private stream aggregation (PSA) which has been used to securely aggregate client-held data, but for purposes of statistics collection. Note that PSA protocols tend to be “one-shot”, i.e., clients send exactly one message to the server, per iteration. Unlike PSA, secure aggregation is expected to work in situations where the client's participation is highly volatile, the high-dimension update space (e.g., model weights), and possibly requires multiple iterations to achieve convergence. This prompted the study of securely aggregating but in an extremely dynamic participation setting.

Recent works have focused on solutions to the secure aggregation problem for applications to federated learning. Unfortunately, these solutions often come with several rounds of participation, on the part of the client. It is to be noted that the likelihood of clients dropping out increases with the increase in the number of rounds. It is to be noted that, at its core, secure aggregation is a multiparty computation (MPC) problem, where minimizing interaction is a highly sought-after objective. Indeed, in MPC, each communication round is costly, and ensuring the liveness of participants, particularly in scenarios involving a large number of parties, poses significant challenges. Unlike throughput, latency is now primarily constrained by physical limitations, making it exceedingly difficult to substantially reduce the time required for a communication round. Furthermore, non-interactive primitives offer increased versatility and are better suited as foundational building blocks. This prompts the crucial question: Is it possible to further reduce interaction? Generally, the answer is negative. The underlying reason is that any non-interactive protocol, which operates with a single communication round, becomes susceptible to a vulnerability referred to as the “residual attack” where the server can collude with some clients and evaluate the function on as many inputs as they wish revealing the inputs of the honest parties.

Accordingly, there is a need for a mechanism for providing a secure aggregation protocol that minimizes interactions in secure computations in order to reduce costs and mitigate challenges of communication rounds while preserving security guarantees.

### SUMMARY

The present disclosure, through one or more of its various aspects, embodiments, and/or specific features or sub-components, provides, inter alia, various systems, servers, devices, methods, media, programs, and platforms for providing a secure aggregation protocol that minimizes interactions in secure computations in order to reduce costs and mitigate challenges of communication rounds while preserving security guarantees.

According to an aspect of the present disclosure, a method for aggregating data is provided. The method is implemented by at least one processor. The method includes: receiving, by the at least one processor from each of a plurality of first users, a respective first ciphertext that masks a respective first input; forwarding, by the at least one processor to each of a plurality of second users, a respective second ciphertext received from each of the plurality of first users; receiving, by the at least one processor from each of the plurality of second users, a respective second input that relates to a respective combination of third inputs recovered from the respective second ciphertexts received by each second user from each of the plurality of first users; combining, by the at least one processor, the received second inputs in order to generate a first unmasking component; combining, by the at least one processor, the first ciphertexts in order to generate an aggregated ciphertext; and generating, by the at least one processor, an unmasked aggregate of the first inputs by using the first unmasking component and the aggregated ciphertext. An unmasked version of each respective first input is unknowable by the at least one processor.

For a particular one of the plurality of first users, the respective first ciphertext may be computed by using a respective seed for a seed-homomorphic pseudorandom generator that is associated with the particular one of the plurality of first users.

The seed for the seed-homomorphic pseudorandom generator may be expanded in order to produce at least one pseudorandom output that is secure under a Learning With Rounding (LWR) assumption and a Learning With Errors (LWE) assumption.

Each of the third inputs may be generated by using a corresponding share of the respective seed that uses a Shamir secret sharing process over at least one prime-order field to distribute the respective seed.

Each of the respective second ciphertexts received by each second user from each of the plurality of first users may include an encryption of a respective one of the third inputs.

For a particular one of the plurality of second users, the respective combination of the third inputs may be generated by performing addition modulo a prime associated with the at least one prime-order field.

The using of the first unmasking component may be based on the seed-homomorphism property.

When a number of first users included in the plurality of first users is equal to N, a number of second users included in the plurality of second users may be a least positive integer that is greater than M.

According to another aspect of the present disclosure, a computing apparatus for securely aggregating data while preserving privacy of individual participants is provided. The computing apparatus includes a processor; a memory; and a communication interface coupled to each of the processor and the memory. The processor is configured to: receive, via the communication interface from each of a plurality of first users, a respective first ciphertext that masks a respective first input; forward, via the communication interface to each of a plurality of second users, a respective second ciphertext received from each of the plurality of first users; receive, via the communication interface from each of the plurality of second users, a respective second input that relates to a respective combination of third inputs recovered from the respective second ciphertexts received by each second user from each of the plurality of first users; combine the received second inputs in order to generate a first unmasking component; combine the first ciphertexts in order to generate an aggregated ciphertext; and generate an unmasked aggregate of the first inputs by using the first unmasking component and the aggregated ciphertext. An unmasked version of each respective first input is unknowable by the at least one processor.

For a particular one of the plurality of first users, the respective first ciphertext may be computed by using a respective seed for a seed-homomorphic pseudorandom generator that is associated with the particular one of the plurality of first users.

The seed for the seed-homomorphic pseudorandom generator may be expanded in order to produce at least one pseudorandom output that is secure under a Learning With Rounding (LWR) assumption and a Learning With Errors (LWE) assumption.

Each of the third inputs may be generated by using a corresponding share of the respective seed that uses a Shamir secret sharing process over at least one prime-order field to distribute the respective seed.

Each of the respective second ciphertexts received by each second user from each of the plurality of first users may include an encryption of a respective one of the third inputs.

For a particular one of the plurality of second users, the respective combination of the third inputs may be generated by performing addition modulo a prime associated with the at least one prime-order field.

The use of the first unmasking component may be based on the seed-homomorphism property.

When a number of first users included in the plurality of first users is equal to N, a number of second users included in the plurality of second users may be a least positive integer that is greater than M.

According to yet another aspect of the present disclosure, a non-transitory computer readable storage medium storing instructions for securely aggregating data while preserving privacy of individual participants is provided. The storage medium includes executable code which, when executed by a processor, causes the processor to: receive, from each of a plurality of first users, a respective first ciphertext that masks a respective first input; forward, to each of a plurality of second users, a respective second ciphertext received from each of the plurality of first users; receive, from each of the plurality of second users, a respective second input that relates to a respective combination of third inputs recovered from the respective second ciphertexts received by each second user from each of the plurality of first users; combine the received second inputs in order to generate a first unmasking component; combine the first ciphertexts in order to generate an aggregated ciphertext; and generate an unmasked aggregate of the first inputs by using the first unmasking component and the aggregated ciphertext. An unmasked version of each respective first input is unknowable by the processor.

For a particular one of the plurality of first users, the respective first ciphertext may be computed by using a respective seed for a seed-homomorphic pseudorandom generator that is associated with the particular one of the plurality of first users.

The seed for the seed-homomorphic pseudorandom generator may be expanded in order to produce at least one pseudorandom output that is secure under a Learning With Rounding (LWR) assumption and a Learning With Errors (LWE) assumption.

Each of the third inputs may be generated by using a corresponding share of the respective seed that uses a Shamir secret sharing process over at least one prime-order field to distribute the respective seed.

Each of the respective second ciphertexts received by each second user from each of the plurality of first users may include an encryption of a respective one of the third inputs.

For a particular one of the plurality of second users, the respective combination of the third inputs may be generated by performing addition modulo a prime associated with the at least one prime-order field.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing a secure aggregation protocol that minimizes interactions in secure computations in order to reduce costs and mitigate challenges of communication rounds while preserving security guarantees.

FIG. 4 is a flowchart of an exemplary process for providing a secure aggregation protocol that minimizes interactions in secure computations in order to reduce costs and mitigate challenges of communication rounds while preserving security guarantees.

FIG. 5 is a diagram that illustrates a communication system flow that is usable in connection with a method for providing a secure aggregation protocol that minimizes interactions in secure computations in order to reduce costs and mitigate challenges of communication rounds while preserving security guarantees, according to an exemplary embodiment.

FIG. 6 is a diagram that illustrates a construction of a one-shot private aggregation protocol based on a seed-homomorphic pseudorandom generator with an appropriate secret-sharing scheme over a particular prime-field, that is usable for implementing a method for providing a secure aggregation protocol that minimizes interactions in secure computations in order to reduce costs and mitigate challenges of communication rounds while preserving security guarantees, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

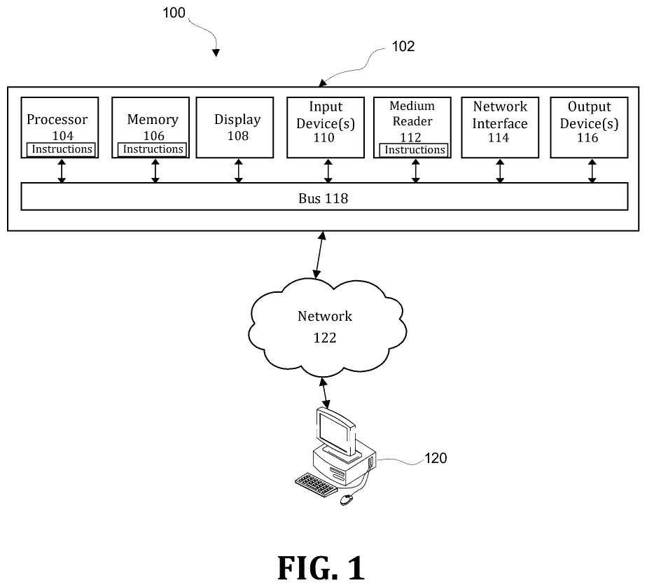

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing a secure aggregation protocol that minimizes interactions in secure computations in order to reduce costs and mitigate challenges of communication rounds while preserving security guarantees.

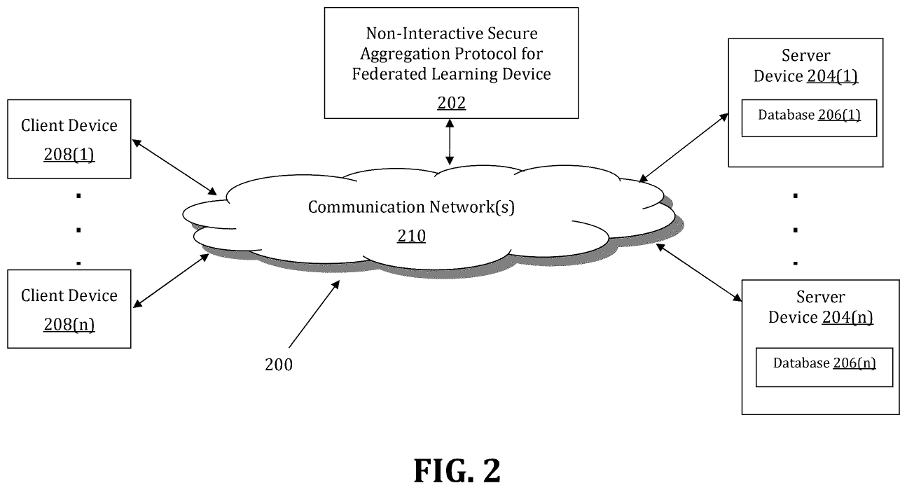

Referring to FIG. 2, a schematic of an exemplary network environment 200 for implementing a method for providing a secure aggregation protocol that minimizes interactions in secure computations in order to reduce costs and mitigate challenges of communication rounds while preserving security guarantees is illustrated. In an exemplary embodiment, the method is executable on any networked computer platform, such as, for example, a personal computer (PC).

The method for providing a secure aggregation protocol that minimizes interactions in secure computations in order to reduce costs and mitigate challenges of communication rounds while preserving security guarantees may be implemented by a Non-Interactive Secure Aggregation Protocol for Federated Learning (NISAPFL) device 202. The NISAPFL device 202 may be the same or similar to the computer system 102 as described with respect to FIG. 1. The NISAPFL device 202 may store one or more applications that can include executable instructions that, when executed by the NISAPFL device 202, cause the NISAPFL device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the NISAPFL device 202 itself, may be located in virtual server(s) running in a cloud-based computing environment rather than being tied to one or more specific physical network computing devices. Also, the application(s) may be running in one or more virtual machines (VMs) executing on the NISAPFL device 202. Additionally, in one or more embodiments of this technology, virtual machine(s) running on the NISAPFL device 202 may be managed or supervised by a hypervisor.

In the network environment 200 of FIG. 2, the NISAPFL device 202 is coupled to a plurality of server devices 204(1)-204(n) that hosts a plurality of databases 206(1)-206(n), and also to a plurality of client devices 208(1)-208(n) via communication network(s) 210. A communication interface of the NISAPFL device 202, such as the network interface 114 of the computer system 102 of FIG. 1, operatively couples and communicates between the NISAPFL device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the NISAPFL device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and NISAPFL devices that efficiently implement a method for providing a secure aggregation protocol that minimizes interactions in secure computations in order to reduce costs and mitigate challenges of communication rounds while preserving security guarantees.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The NISAPFL device 202 may be a standalone device or integrated with one or more other devices or apparatuses, such as one or more of the server devices 204(1)-204(n), for example. In one particular example, the NISAPFL device 202 may include or be hosted by one of the server devices 204(1)-204(n), and other arrangements are also possible. Moreover, one or more of the devices of the NISAPFL device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the NISAPFL device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store public exchange data and parameters that are usable for implementing a method and a system for providing a secure aggregation protocol that minimizes interactions in secure computations in order to reduce costs and mitigate challenges of communication rounds while preserving security guarantees.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the NISAPFL device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the NISAPFL device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the NISAPFL device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the NISAPFL device 202, the server devices 204(1)-204(n), or the client devices 208(1)-208(n), for example, may be configured to operate as virtual instances on the same physical machine. In other words, one or more of the NISAPFL device 202, the server devices 204(1)-204(n), or the client devices 208(1)-208(n) may operate on the same physical device rather than as separate devices communicating through communication network(s) 210. Additionally, there may be more or fewer NISAPFL devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

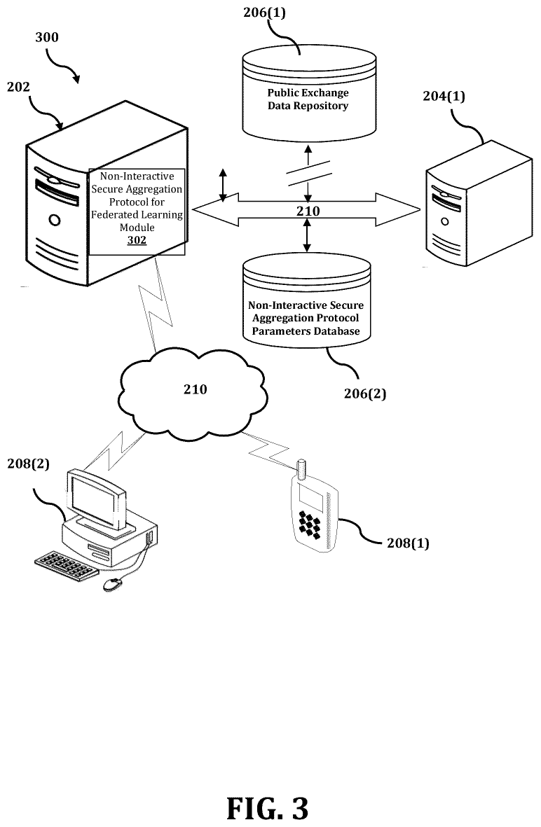

The NISAPFL device 202 is described and illustrated in FIG. 3 as including a non-interactive secure aggregation protocol for federated learning module 302, although it may include other rules, policies, modules, databases, or applications, for example. As will be described below, the non-interactive secure aggregation protocol for federated learning module 302 is configured to implement a method for providing a secure aggregation protocol that minimizes interactions in secure computations in order to reduce costs and mitigate challenges of communication rounds while preserving security guarantees.

An exemplary process 300 for implementing a system for providing a secure aggregation protocol that minimizes interactions in secure computations in order to reduce costs and mitigate challenges of communication rounds while preserving security guarantees by utilizing the network environment of FIG. 2 is illustrated as being executed in FIG. 3. Specifically, a first client device 208(1) and a second client device 208(2) are illustrated as being in communication with NISAPFL device 202. In this regard, the first client device 208(1) and the second client device 208(2) may be “clients” of the NISAPFL device 202 and are described herein as such. Nevertheless, it is to be known and understood that the first client device 208(1) and/or the second client device 208(2) need not necessarily be “clients” of the NISAPFL device 202, or any entity described in association therewith herein. Any additional or alternative relationship may exist between either or both of the first client device 208(1) and the second client device 208(2) and the NISAPFL device 202, or no relationship may exist.

Further, NISAPFL device 202 is illustrated as being able to access a public exchange data repository 206(1) and a non-interactive secure aggregation protocol parameters database 206(2). The non-interactive secure aggregation protocol for federated learning module 302 may be configured to access these databases for implementing a method for providing a secure aggregation protocol that minimizes interactions in secure computations in order to reduce costs and mitigate challenges of communication rounds while preserving security guarantees.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the NISAPFL device 202 via broadband or cellular communication. Of course, these embodiments are merely exemplary and are not limiting or exhaustive.

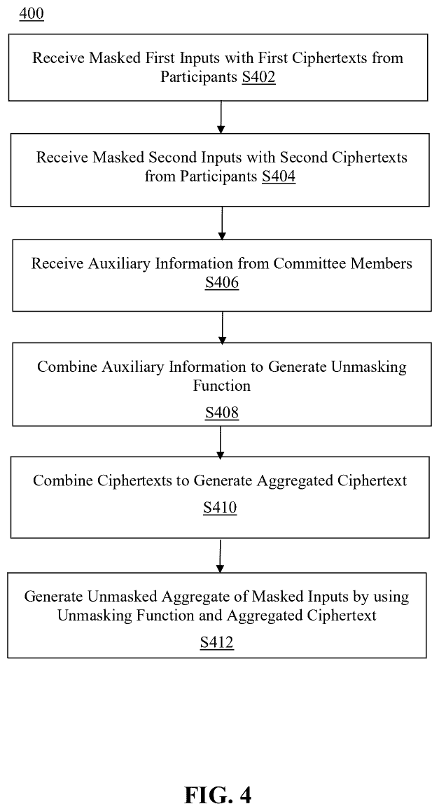

Upon being started, the non-interactive secure aggregation protocol for federated learning module 302 executes a process for providing a secure aggregation protocol that minimizes interactions in secure computations in order to reduce costs and mitigate challenges of communication rounds while preserving security guarantees. An exemplary process for providing a secure aggregation protocol that minimizes interactions in secure computations in order to reduce costs and mitigate challenges of communication rounds while preserving security guarantees is generally indicated at flowchart 400 in FIG. 4.

In process 400 of FIG. 4, at step S402, the non-interactive secure aggregation protocol for federated learning module 302 receives, from each of a plurality of first users, a respective first ciphertext and that masks a respective first input. In an exemplary embodiment, for each first user, the first input includes sensitive information that the first user wishes to remain secret, and so the first input is masked by using the first ciphertext. In an exemplary embodiment, for each particular first user, the first ciphertext is computed by using a respective seed for a seed-homomorphic pseudorandom generator (SHPRG) that is associated with that particular first user. In this aspect, the pseudorandom function may be expanded at a current iteration value with respect to the seed that is sampled by that particular first user. In an exemplary embodiment, the seed for the SHPRG may be expanded in order to produce at least one pseudorandom output that is secure under a Learning With Rounding (LWR) assumption and/or a Learning With Errors (LWE) assumption.

At step S404, the non-interactive secure aggregation protocol for federated learning module 302 receives, from each of the plurality of first users, a respective second input that is masked by using a respective second ciphertext. In an exemplary embodiment, for each first user, the second input includes sensitive information that the first user wishes to remain secret and only available to the second users. In an exemplary embodiment, for each particular first user and each particular second user, the respective second ciphertext is computed by encrypting to the particular second user through any public-key encryption scheme with knowledge of the respective public key of the particular second user. In this aspect, for each particular second user, the share of the seed that is sampled by the particular first user is computed by using an R-out-of-M Shamir secret sharing process over prime-order fields.

At step S406, the non-interactive secure aggregation protocol for federated learning module 302 receives, from each of a plurality of second users, a respective third input that represents auxiliary information that relates to a respective combination of fourth inputs received by each second user from each of the plurality of first users. In an exemplary embodiment, each respective second input is recovered by using a respective second ciphertext that is forward to each second user from a respective first user. In an exemplary embodiment, the plurality of second users may be understood as being a committee, and when the number of first users included in the plurality of first users is equal to N, the number of second users included in the committee may be equal to a least positive integer that is greater than or equal to M. In an exemplary embodiment, for each particular committee member, the respective second ciphertext may be decrypted by using the knowledge of the secret-key. In an exemplary embodiment, for each particular committee member, the combination of the received fourth inputs may be generated by performing addition modulo a prime integer associated with the at least one prime-order field.

At step S408, the non-interactive secure aggregation protocol for federated learning module 302 combines the auxiliary information received in step S404 in order to generate an unmasking component, by expanding the use of the SHPRG with respect to the combined auxiliary information. The unmasking component is usable for unmasking an aggregation of the first inputs, but is not usable for unmasking any individual first input. Then, at step S410, the non-interactive secure aggregation protocol for federated learning module 302 combines the first ciphertexts received in step S402 in order to generate an aggregated ciphertext.

At step S412, the non-interactive secure aggregation protocol for federated learning module 302 generates an unmasked aggregate of the first inputs by using the first unmasking component and the aggregated ciphertext. In this aspect, the non-interactive secure aggregation protocol for federated learning module 302 is able to obtain the unmasked aggregate of the first inputs, even as an unmasked version of each individual first input remains unknowable by the non-interactive secure aggregation protocol for federated learning module 302. In an exemplary embodiment, the use of the unmasking component may be based on the seed-homomorphism property.

In an embodiment, there is an exploration of a natural “hybrid” model for addressing the secure aggregation problem that sits between the 2-round and 1-round settings. In this aspect, the model allows for private aggregation, aided by a committee of members, where the client only speaks once. This approach represents an improvement with respect to achieving non-interactive protocols while preserving traditional security guarantees. In an embodiment, the specific focus is within the domain of secure aggregation protocols, where a group of n clients Pᵢ for i∈[n] hold a private value xᵢ, wish to learn the sum Σᵢxᵢ without leaking any information about the individual xᵢ. In this model, clients release encoded versions of their confidential inputs xᵢ to a designated committee of ephemeral members and they go offline, they only speak once. Later, any subset of the ephemeral members can compute these encodings by simply transmitting a single public message to an unchanging, stateless evaluator or server. This message conveys solely the outcome of the secure aggregation and nothing else. Of significant note, the ephemeral members are stateless, speak only once, and can change (or not) per aggregation session. With that in mind, the committee members can be regarded as another subset of clients who abstain from contributing input when they are selected to serve on the committee during a current aggregation session. Each client/committee member communicates just once per aggregation, eliminating the complexity of handling dropouts commonly encountered in multi-round secure aggregation protocols. The security guarantee is that an adversary corrupting a subset of clients and the committee members learn no information about the private inputs of honest clients, beyond the outputs of the aggregations they participated in. This holds for any polynomial number of computation sessions.

In an embodiment, there is a focus on building a primitive, One-shot Private Aggregation (OPA), that enables privacy-preserving aggregation of multiple inputs, across several aggregation iterations whereby a client only speaks once on his will, per iteration. The main technical tool in building this primitive is a seed homomorphic pseudorandom generator.

In an exemplary embodiment, a construction is provided for a primitive, One-shot Private Aggregation (OPA) that enables privacy-preserving aggregation of multiple inputs, across several aggregation iterations whereby a client only speaks once on his will, per iteration.

In an exemplary embodiment, a Seed-Homomorphic PRG (SHPRG) may be defined as follows: A PRG G: [symbol] → [symbol] is said to be seed-homomorphic if G(s₁⊗s₂)=G(s₁)⊗G(s₂) where (⊗, [symbol] ) and (⊗, [symbol] ) are groups. A showing of how to build SHPRG from the LWR Assumption and the LWE Assumption may be made. For ease of exposition, a focus is placed on the LWR construction.

For a randomly chosen

$$A ← {ℤ}_{q}^{L \times n} , \text{?} := {ℤ}_{q}^{n} , s ← \text{?} , PR {G}_{LWR , A} ( s ) = {⌊ As ⌋}_{p} where p < q .$$

However, this construction is only almost seed-homomorphic in that there is an induced error: PRG_{LWR,A} (s₁+s₂)=PRG_{LWR,A}(s₁)+PRG_{LWR,A} (s₂)+e, where e∈{0,1}^{L}, for any choice of s₁, s₂∈

$${ℤ}_{q}^{n} .$$

Syntactically, the computation of the PRG is denoted by an associated algorithm PRG. Expand.

In an exemplary embodiment, secret sharing over finite fields may be performed in accordance with the following. In standard Shamir secret sharing, one picks a secret s and generate a polynomial

$$f ( X ) = {\sum }_{i = 0}^{r - 1} {a}_{i} \cdot {X}^{i}$$

where a₀=s and a₁, . . . , aᵣ₋₁ are randomly chosen from the field. Assuming there are m parties, the share for party i∈[m] is f(i), and any subset of at least r parties can reconstruct s and any subset of r−1 shares are independently random. The corruption threshold may be lowered from r−1 to t to obtain additional properties from the scheme. In packed secret sharing, one can hide multiple secrets using a single polynomial.

In an exemplary embodiment, a one-shot private aggregation (OPA) that is based on SHPRG may be constructed as follows. An objective is to empower a client to speak once, per iteration, and help the server successfully aggregate long vectors having a length L. To this end, the client communicates at the same time with the server and to a set of committee members, via the server. An assumption may be made that there is a public key infrastructure (PKI) or a mechanism to retrieve the public key of these committee members so that the communication to the committee can be encrypted. In an exemplary embodiment, the committee may include m ephemerally chosen clients who are tasked with helping the server aggregate, for that iteration. In an exemplary embodiment, the client i samples a seed from the seed space of the PRG, i.e., sdᵢ←PRG. [symbol] . Then, the PRG is expanded under this seed sᵢ and effectively serves as a mask for input [symbol] . Here [symbol] is the current iteration number. In other words, it computes [symbol] = [symbol] +PRG.Expand (sdᵢ). Intuitively, the PRG security implies that the evaluation is pseudorandom and is an effective mask for the input. Then, the client secret shares using standard Shamir's Secret Sharing, sdᵢ to get shares

$${\{ s {d}_{i}^{( j )} \}}_{j ∈ [ m ]} .$$

This is performed by evaluating the algorithm

$${\{ s {d}_{i , ℓ}^{( j )} \}}_{j ∈ [ m ]} ← SS . Share ( {sd}_{i , ℓ} , t , r , m )$$

where SS denotes the Secret Sharing scheme, r is the number of shares needed for reconstruction, and t is the corruption threshold. Share

$$s {d}_{i}^{( j )}$$

is sent to committee member j, via the server through an appropriate encryption algorithm. Upon receiving the encrypted share, the committee member decrypts to recover the share. Each committee member simply adds up the shares, using the linear homomorphism property of Shamir's secret sharing. The linear homomorphism property guarantees that given shares

$${s}_{1}^{( j )} , {s}_{2}^{( j )}$$

corresponding to two secrets s₁, s₂ for the same committee member j, then

$${s}_{1}^{( j )} + {s}_{2}^{( j )}$$

is a valid share of s₁+s₂. After receiving from the clients for that round, the committee member j sends the added shares, which corresponds to

$${\sum }_{i = 1}^{n} s {d}_{i}^{( j )} .$$

The server can successfully reconstruct from the information sent by the committee to get

$${\sum }_{i = 1}^{n} s {d}_{i} .$$

For this, the server requires a set [symbol] of

$$\text{?}$$

where | [symbol] |≥r. The server runs the algorithm

$$s {d}_{ℓ} ← SS . Reconstruct ( \{ \text{?} \} )$$

which is the algorithm used to reconstruct the original secret from shares of the secret, associated with the Secret Sharing scheme SS. Note that adding up the ciphertext from the clients results in

$${\sum }_{i = 1}^{n} c {t}_{i , ℓ} = {\sum }_{i = 1}^{n} {x}_{i , ℓ} + {\sum }_{i = 1}^{n} PRG . Expand ( {sd}_{i} ) .$$

Seed Homomorphism of the PRG implies that

$${\sum }_{i = 1}^{n} PRG . Expand ( {sd}_{i} ) = PRG . Expand ( {\sum }_{i = 1}^{n} s {d}_{i} ) .$$

Note that the server, with the reconstructed information, can compute PRG.

$$PRG . Expand ( {\sum }_{i = 1}^{n} s {d}_{i} )$$

and subtract it from

$${\sum }_{i = 1}^{n} c {t}_{i , ℓ}$$

to recover the intended sum.

In an exemplary embodiment, there may be caveats. First, the server recovers the sum of the seeds

$${\sum }_{i = 1}^{n} s {d}_{i} ,$$

which constitutes a leakage on the seed of the PRG. In this aspect, a leakage-resilient, seed homomorphic PRG may be required. Second, LWR and the LWE based construction of seed homomorphic PRG are only almost seed homomorphic. Thus, it is important to encode and decode to ensure that the correct sum is recovered. It may be shown that the LWR and LWE based schemes are seed-homomorphic and leakage-resilient while describing the necessary encoding and decoding algorithms for the input. In an exemplary embodiment, the seed shared with the committee is usually independent of the vector length.

OPA may be effective against malicious clients. In an embodiment, a publicly verifiable secret-sharing scheme that employs a combination of SCRAPE with simple Σ-protocol is used. As a result, the server can verify that given the commitment to shares, the shares are indeed a valid Shamir Secret Sharing. Meanwhile, the committee member simply needs to verify if the commitment to the share matches its encrypted share with the committee member raising an alarm should the check fail.

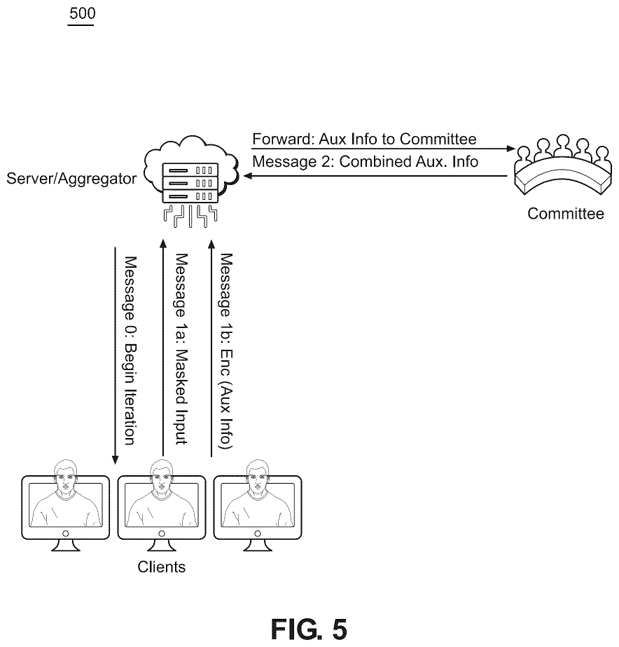

FIG. 5 is a diagram 500 that illustrates a communication system flow that is usable in connection with a method for providing a secure aggregation protocol that minimizes interactions in secure computations in order to reduce costs and mitigate challenges of communication rounds while preserving security guarantees, according to an exemplary embodiment. As shown in FIG. 5, an OPA system model may operate in iterations. Each iteration may begin with a server sending a message to initiate the process, i.e., Message 0. In response, clients may train the model on their local data, obtain updates, and mask the input. Message 1 may include a masked input that is sent to the server, while auxiliary information is transmitted, via encryption to the committee via the server. Upon receiving the forwarded information, the committee members may combine these into a single value. Lastly, the consolidated data may be sent to the server as Message 2, thereby concluding the iteration.

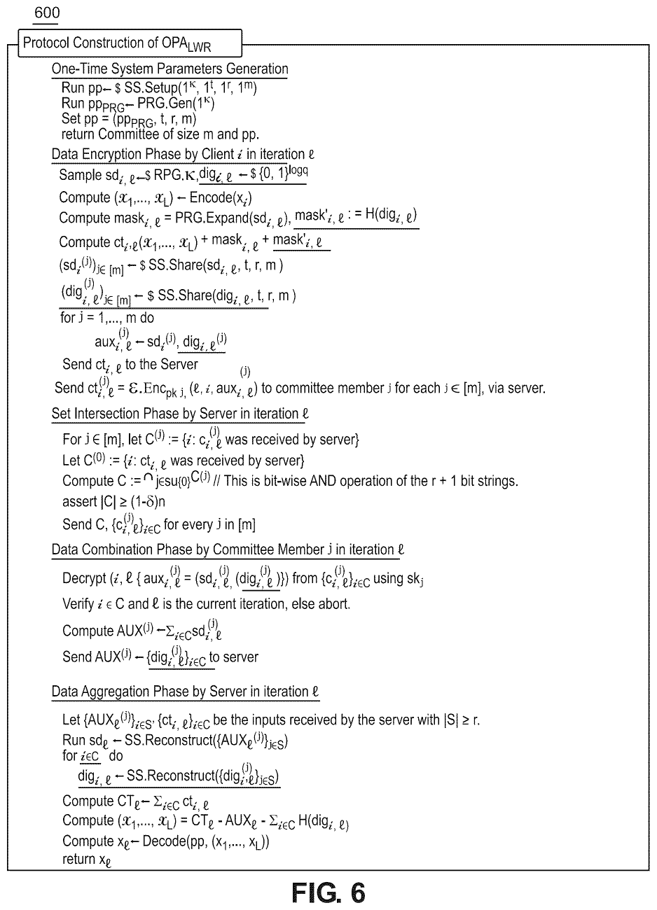

FIG. 6 is a diagram 600 that illustrates a construction of a one-shot private aggregation protocol based on a seed-homomorphic pseudorandom generator with an appropriate secret-sharing scheme over a particular prime-field, that is usable for implementing a method for providing a secure aggregation protocol that minimizes interactions in secure computations in order to reduce costs and mitigate challenges of communication rounds while preserving security guarantees, according to an exemplary embodiment. The seed-homomorphic pseudorandom generator PRG has an associated seed space K and an algorithm PRG. Expand that takes as input the seed and produces an output which is a vector of length L. The secret sharing scheme SS has an associated algorithm SS.Share that takes as input a secret, the corruption threshold t, the reconstruction threshold r, and the total number of shares needed m. The output are m shares of the secret of which at least r is needed to reconstruct the original secret and any t of them do not leak any information about the secret. There is also an associated algorithm SS. Reconstruct that takes as input at least r shares and produces the original secret. As shown in FIG. 6,

$$Encode ( {x}_{i , ℓ} ) = n \cdot {x}_{i , ℓ} + 1 and Decode ( {X}_{i} ) := ⌊ \frac{{X}_{i}}{n} ⌋ - 1.$$

The underscoring lines are for security against an active server. The use of the second mask

$${mask}_{i , ℓ}^{′}$$

as an output of H is needed for the simulation-based proof of the theorem statement for security against an active server. In an embodiment, His modeled as a programmable random oracle.

Accordingly, with this technology, an optimized process for providing a secure aggregation protocol that minimizes interactions in secure computations in order to reduce costs and mitigate challenges of communication rounds while preserving security guarantees is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for securely aggregating data while preserving privacy of individual participants, the method being implemented by at least one processor, the method comprising:
receiving, by the at least one processor from each of a plurality of first users, a respective first ciphertext that masks a respective first input;
forwarding, by the at least one processor to each of a plurality of second users, a respective second ciphertext received from each of the plurality of first users;
receiving, by the at least one processor from each of the plurality of second users, a respective second input that relates to a respective combination of third inputs recovered from the respective second ciphertexts received by each second user from each of the plurality of first users;
combining, by the at least one processor, the received second inputs in order to generate a first unmasking component;
combining, by the at least one processor, the first ciphertexts in order to generate an aggregated ciphertext; and
generating, by the at least one processor, an unmasked aggregate of the first inputs by using the first unmasking component and the aggregated ciphertext,
wherein an unmasked version of each respective first input is unknowable by the at least one processor.

2. The method of claim 1, wherein for a particular one of the plurality of first users, the respective first ciphertext is computed by using a respective seed for a seed-homomorphic pseudorandom generator that is associated with the particular one of the plurality of first users.

3. The method of claim 2, wherein the seed for the seed-homomorphic pseudorandom generator is expanded in order to produce at least one pseudorandom output that is secure under a Learning With Rounding (LWR) assumption and a Learning With Errors (LWE) assumption.

4. The method of claim 1, wherein each of the third inputs is generated by using a corresponding share of the respective seed that uses a Shamir secret sharing process over at least one prime-order field to distribute the respective seed.

5. The method of claim 4, wherein each of the respective second ciphertexts received by each second user from each of the plurality of first users comprises an encryption of a respective one of the third inputs.

6. The method of claim 4, wherein for a particular one of the plurality of second users, the respective combination of the third inputs is generated by performing addition modulo a prime associated with the at least one prime-order field.

7. The method of claim 6, wherein the using of the first unmasking component is based on the seed-homomorphism property.

8. The method of claim 1, wherein when a number of first users included in the plurality of first users is equal to N, a number of second users included in the plurality of second users is a least positive integer that is greater than M.

9. A computing apparatus for securely aggregating data while preserving privacy of individual participants, the computing apparatus comprising:
a processor;
a memory; and
a communication interface coupled to each of the processor and the memory,
wherein the processor is configured to:
receive, via the communication interface from each of a plurality of first users, a respective first ciphertext that masks a respective first input;
forward, via the communication interface to each of a plurality of second users, a respective second ciphertext received from each of the plurality of first users;
receive, via the communication interface from each of the plurality of second users, a respective second input that relates to a respective combination of third inputs recovered from the respective second ciphertexts received by each second user from each of the plurality of first users;
combine the received second inputs in order to generate a first unmasking component;
combine the first ciphertexts in order to generate an aggregated ciphertext; and
generate an unmasked aggregate of the first inputs by using the first unmasking component and the aggregated ciphertext,
wherein an unmasked version of each respective first input is unknowable by the at least one processor.

10. The computing apparatus of claim 9, wherein for a particular one of the plurality of first users, the respective first ciphertext is computed by using a respective seed for a seed-homomorphic pseudorandom generator that is associated with the particular one of the plurality of first users.

11. The computing apparatus of claim 10, wherein the seed for the seed-homomorphic pseudorandom generator is expanded in order to produce at least one pseudorandom output that is secure under a Learning With Rounding (LWR) assumption and a Learning With Errors (LWE) assumption.

12. The computing apparatus of claim 9, wherein each of the third inputs is generated by using a corresponding share of the respective seed that uses a Shamir secret sharing process over at least one prime-order field to distribute the respective seed.

13. The computing apparatus of claim 12, wherein each of the respective second ciphertexts received by each second user from each of the plurality of first users comprises an encryption of a respective one of the third inputs.

14. The computing apparatus of claim 12, wherein for a particular one of the plurality of second users, the respective combination of the third inputs is generated by performing addition modulo a prime associated with the at least one prime-order field.

15. The computing apparatus of claim 14, wherein the use of the first unmasking component is based on the seed-homomorphism property.

16. A non-transitory computer readable storage medium storing instructions for securely aggregating data while preserving privacy of individual participants, the storage medium comprising executable code which, when executed by a processor, causes the processor to:
receive, from each of a plurality of first users, a respective first ciphertext that masks a respective first input;
forward, to each of a plurality of second users, a respective second ciphertext received from each of the plurality of first users;
receive, from each of the plurality of second users, a respective second input that relates to a respective combination of third inputs recovered from the respective second ciphertexts received by each second user from each of the plurality of first users;
combine the received second inputs in order to generate a first unmasking component;
combine the first ciphertexts in order to generate an aggregated ciphertext; and
generate an unmasked aggregate of the first inputs by using the first unmasking component and the aggregated ciphertext,
wherein an unmasked version of each respective first input is unknowable by the processor.

17. The storage medium of claim 16, wherein for a particular one of the plurality of first users, the respective first ciphertext is computed by using a respective seed for a seed-homomorphic pseudorandom generator that is associated with the particular one of the plurality of first users.

18. The storage medium of claim 17, wherein the seed for the seed-homomorphic pseudorandom generator is expanded in order to produce at least one pseudorandom output that is secure under a Learning With Rounding (LWR) assumption and a Learning With Errors (LWE) assumption.

19. The storage medium of claim 16, wherein each of the third inputs is generated by using a corresponding share of the respective seed that uses a Shamir secret sharing process over at least one prime-order field to distribute the respective seed.

20. The storage medium of claim 19, wherein each of the respective second ciphertexts received by each second user from each of the plurality of first users comprises an encryption of a respective one of the third inputs.
